(19) United States
(12) Patent Application Publication
(10) Pub. No.: US 2007/0047932 A1
(43) Pub. Date: Mar. 1, 2007

(54) Waveguide for plastics welding using an incoherent infrared light source

(75) Inventors: Scott Caldwell, Henrietta, NY (US); Kenneth Nelson, Rochester, NY (US); Daniel D. Hershey, Fairport, NY (US)

Correspondence Address: HARNESS, DICKEY & PIERCE, P.L.C., P.O. BOX 828, BLOOMFIELD HILLS, MI, 48303, US

(73) Assignee: Branson Ultrasonics Corporation

(21) Appl. No.: 11/520,227

(22) Filed: Sep. 13, 2006

Related U.S. Application Data
(63) Continuation-in-part of application No. 11/216,711, filed on Aug. 31, 2005, now abandoned.

(51) Int. Cl. F21V 7/00; G02B 17/00

(52) U.S. Cl. 392/419

(57) ABSTRACT

An assembly for producing a weld coupling a first part of a workpiece to a second part of the workpiece. The assembly comprises a first incoherent light source that generates incoherent light energy and a first negative waveguide having an input end and an output end, the incoherent light energy from the first incoherent light source and that reflected by the first reflector entering the first negative waveguide at the input end, passing through the first negative waveguide and exiting the first negative waveguide at the output end. The first negative waveguide having a non-conical longitudinal cross section producing a non-circular weld zone

### CROSS-REFERENCE TO RELATED APPLICATIONS

This application is a continuation-in-part of U.S. patent application Ser. No. 11/216,711 filed on Aug. 31, 2005. The disclosure of the above application is incorporated herein by reference.

### FIELD OF THE INVENTION

The present invention relates generally to plastics welding and, more particularly, relates to waveguides for use with an incoherent infrared light source for plastics welding.

### BACKGROUND AND SUMMARY OF THE INVENTION

Currently, the art of welding plastic or resinous parts incorporates a variety of techniques including ultrasonic welding, heat welding, and, most recently, Through Transmission Infrared (TTIr) welding.

TTIR welding employs infrared light passed through a first plastic part and into a second plastic part. TTIR welding can use either infrared laser light or incoherent infrared light in the current art. Infrared laser light in the current art can be directed by fiber optics, waveguides, or light guides through the first plastic part and into a second plastic part. This first plastic part is often referred to as the transmissive piece, since it generally permits the laser beam from the laser to pass therethrough. The second plastic part is often referred to as the absorptive piece, since this piece generally absorbs the radiative energy of the laser beam to produce heat in the welding zone. This heat in the welding zone causes the transmissive piece and the absorptive piece to be melted and thus welded together. However, the heat produced by conventional laser systems often is expensive, which leads to increased production costs. Alternative variations of laser welding can be found in U.S. Pat. No. 4,636,609, which is incorporated herein by reference.

As is well known, lasers in general provide a focused beam of electromagnetic radiation at a specified frequency or range of frequencies. There are a number of types of lasers available that provide a relatively economical source of radiative energy for use in heating a welding zone. This radiative energy produced by the infrared laser can be delivered to the targeted weld zone through a number of transmission devices—such as a single optical fiber, a fiber optic bundle, a waveguide, a light guide, or the like—or simply by directing a laser beam at the targeted weld zone. In the case of a fiber optic bundle, the bundle may be arranged to produce either a single point source laser beam, often used for spot welding, or a generally linearly distributed laser beam, often used for linear welding.

Plastics welding using incoherent infrared light sources to melt plastic can be done. An example of such can be found in commonly-assigned U.S. Pat. No. 6,528,755, which is incorporated herein by reference. There are two main plastics welding processes that are used with incoherent infrared light—part-to-part surface heating infrared welding and TTIr welding.

As seen in FIGS. 1(a)-(c), part-to-part surface heating infrared welding employs an incoherent infrared light source 110 that first heats up plastic parts 112, 114 to be welded. The incoherent light source 110 is then removed (FIG. 1(b)) and the parts 112, 114 are pressed together (FIG. 1(c)). As the parts cool, a bond is formed along the weld interface 116, thereby welding the parts together.

On the other hand, as seen in FIG. 2, TTIr welding, similar as described above, passes incoherent infrared light 120 from an incoherent infrared light source 122 through a first plastic part (transmissive piece) 124 to be welded. This incoherent infrared light 120 is absorbed at the weld line 126 either by the second plastic part (absorptive piece) 128 to be welded, or by a surface additive at the welding zone, thereby heating and melting the transmissive piece 124 and the absorptive piece 128 along the welding zone. Once cooled, the first plastic part 124 and second plastic part 128 are joined.

However, it should be appreciated that the incoherent infrared light source used in these processes directs its energy in all directions, as seen in FIGS. 1 and 2. As seen in FIG. 3, the use of parabolic or elliptical reflectors 140 to try to direct this energy to a specific weld has been attempted, however, such reflectors have failed to reliably and efficiently direct this energy to the specific weld area. Parabolic and elliptical reflectors do concentrate about fifty percent (50%) of the infrared light, but the other fifty percent (50%) spreads out inefficiently.

Masking has been used to try to minimize the infrared energy from reaching areas not to be melted. Although masking successfully prevents the infrared light from reaching areas not to be melted, the infrared light that impacts these masked areas is wasted in the welding process. Accordingly, larger and more expensive incoherent sources are required.

Infrared bulbs are the most commonly known and commonly used incoherent infrared light sources. Typically, these bulbs have a limited lifetime when operated at full power. However, because of inefficiencies of light delivery as described herein, these infrared bulbs have to be operated at full power in order to provide sufficient energy to the weld area to achieve sufficient heating and melting for welding.

A solution to the present challenges comprises an assembly for producing a weld coupling a first part of a workpiece to a second part of the workpiece. The assembly comprises a first incoherent light source that generates incoherent light energy and a first negative waveguide having an input end and an output end, the incoherent light energy from the first incoherent light source and that reflected by the first reflector entering the first negative waveguide at the input end, passing through the first negative waveguide and exiting the first negative waveguide at the output end. The first negative waveguide having a non-conical longitudinal cross section producing a non-circular weld zone

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1(a)-(c) are a series of side views illustrating part-to-part surface heating according to the prior art;

FIG. 2 is a side views illustrating TTIr welding according to the prior art;

FIG. 3 is a side view illustrating a reflector according to the prior art;

FIGS. 4(a)-(c) are a series of side views illustrating part-to-part surface heating according to the principles of the present invention;

FIG. 5 is a side view illustrating TTIr welding according to the principles of the present invention;

FIG. 6(a) is a cross-sectional view of a positive waveguide according to prior art;

FIG. 6(b) is a cross-sectional view of a negative waveguide according to the principles of the present invention;

FIG. 7 is a schematic view illustrating welding according to prior art, using a flexible positive waveguide;

FIG. 8 is a schematic view illustrating a simple conical waveguide;

FIG. 9 is a schematic view illustrating a complex waveguide producing a non-circular spot according to the principles of the present invention;

FIG. 10 is a schematic view illustrating a curvilinear source and curvilinear waveguide according to the principles of the present invention;

FIG. 11 is a schematic view illustrating a curvilinear source and a variable-width curvilinear waveguide according to the principles of the present invention;

FIG. 12 is a schematic view illustrating an intersecting source and intersecting waveguide according to the principles of the present invention;

FIG. 13 is a schematic view illustrating a planar array of elongated sources and a complex waveguide according to the principles of the present invention;

FIG. 14 is a schematic view illustrating a plurality of point sources and a complex waveguide according to the principles of the present invention;

FIG. 15 is a schematic view illustrating a plurality of elongated sources in communication with a single, complex waveguide according to the principles of the present invention;

FIG. 16 is a schematic view illustrating a single source in communication with a plurality of complex waveguides according to the principles of the present invention;

FIG. 17 is a schematic view illustrating a plurality of varying types of sources in communication with a plurality of complex waveguides according to the principles of the present invention;

FIG. 18 is a schematic view illustrating an elongated source in communication with an elongated, tapered waveguide according to the principles of the present invention;

FIG. 19 is a schematic view illustrating an elongated source in communication with an outwardly, tapered waveguide according to the principles of the present invention;

FIG. 20 is a schematic view illustrating an elongated source in communication with a curved waveguide having an output about 90° relative to an input according to the principles of the present invention;

FIG. 21 is a schematic view illustrating an elongated source in communication with a curved waveguide having an output about 90° relative to an input having an angled reflective corner according to the principles of the present invention;

FIG. 22 is a schematic view illustrating a plurality of elongated sources in communication with a U-shaped waveguide and disposed around an outer boundary of the U-shaped waveguide according to the principles of the present invention;

FIG. 23 is a schematic view illustrating a plurality of elongated sources in communication with a U-shaped waveguide and disposed around an inner boundary of the U-shaped waveguide in a non-uniform orientation according to the principles of the present invention;

FIG. 24 is a schematic view illustrating a pair of elongated sources in communication with a pair of primary waveguides and a gap-filling waveguide disposed therebetween according to the principles of the present invention; and

FIG. 25 is a schematic view illustrating a pair of elongated sources in communication with a pair of primary waveguides that overlap each other to provide uniform weld coverage according to the principles of the present invention.

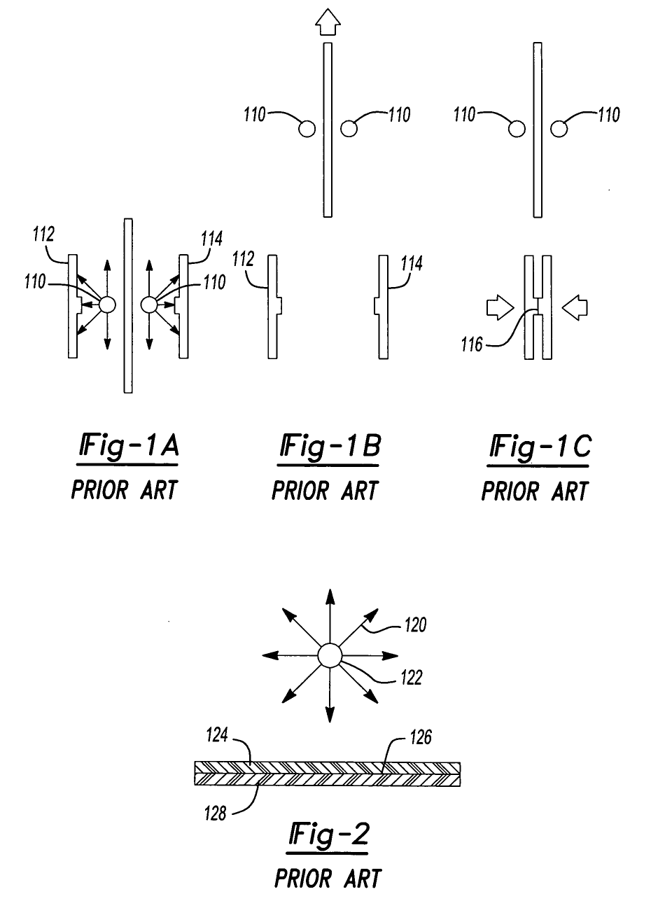

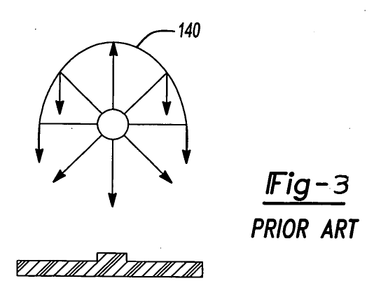

### DETAILED DESCRIPTION OF THE PREFERRED EMBODIMENTS

The following description of the preferred embodiments is merely exemplary in nature and is in no way intended to limit the invention, its application, or uses.

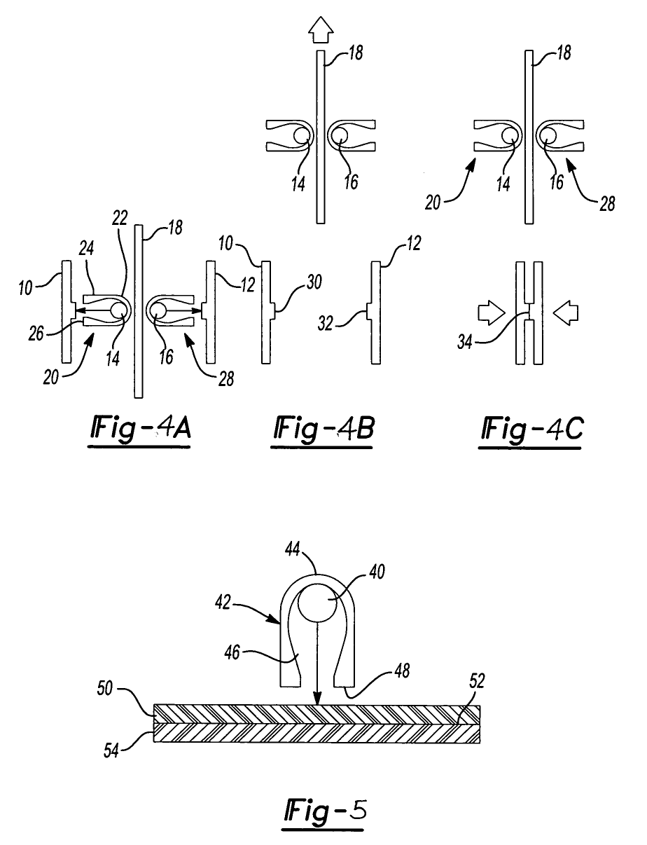

Referring now to FIG. 4, an apparatus and a method for welding a first plastic part 10 to a second plastic part 12 using a first incoherent infrared light source 14 and a second incoherent infrared light source 16 is provided according to the principles of the present teachings. Specifically, first incoherent infrared light source 14 and second incoherent infrared light source 16 are each mounted to and carried by a support structure 18. First incoherent infrared light source 14 is disposed within a first negative waveguide assembly 20. First negative waveguide assembly 20 comprises a reflector portion 22 and a negative waveguide portion 24. In some embodiments, negative waveguide portion 24 is formed integrally with reflector portion 22 to form a single, unitary assembly. In some embodiments, first incoherent infrared light source 14 is positioned at the focus of reflector portion 22.

In some embodiments, reflector portion 22 can be shaped to define any profile conducive for directing incoherent infrared light from first incoherent infrared light source 14 toward negative waveguide portion 24. More particularly, reflector portion 22 may be shaped to define an elliptic or parabolic profile that is capable of directing incoherent infrared light from first incoherent infrared light source 14 along a predetermined direction and distribution within negative waveguide portion 24. In some embodiments, first incoherent infrared light source 14 is positioned at the focus of reflector portion 22. In some embodiments, negative waveguide portion 24 is shaped to receive incoherent infrared light from first incoherent infrared light source 14 and reflector portion 22 and direct and/or carry this incoherent infrared light to an output end 26 thereof. Likewise, second incoherent infrared light source 16 is disposed for use in conjunction with a second negative waveguide assembly 28. Second negative waveguide assembly 28 is identical to first negative waveguide assembly 20, yet is in mirrored relationship thereto. Therefore, in the interest of brevity, a detailed description of second negative waveguide assembly 28 is not deemed necessary.

During operation, first incoherent infrared light source 14 and second incoherent infrared light source 16 are each actuated to output incoherent infrared light. This incoherent infrared light is distributed uniformly and radially from first incoherent infrared light source 14 and second incoherent infrared light source 16. However, any incoherent infrared light that is directed toward reflector portion 22 is redirected and/or focused by reflector portion 22 toward negative waveguide portion 24. Negative waveguide portion 24 further directs and/or carries the incoherent infrared light to output end 26 thereof. Incoherent infrared light exiting output end 26 of first negative waveguide assembly 20 and second negative waveguide assembly 28 is directed to a predetermined portion of first plastic part 10 and second plastic part 12 to locally heat a first weld zone 30 and a second weld zone 32 of first plastic part 10 and second plastic part 12, respectively. Once first weld zone 30 and second weld zone 32 are sufficiently heated through absorption of light energy, support structure 18 is moved relative to first plastic part 10 and second plastic part 12 to permit first plastic part 10 and second plastic part 12 to be pressed together to define a completed weld zone 34.

Referring now to FIG. 5, the principles of the present teachings can be used in connection with TTIr welding. Specifically, an incoherent infrared light source 40 is disposed within a negative waveguide assembly 42. Negative waveguide assembly 42 comprises a reflector portion 44 and a negative waveguide portion 46. In some embodiments, negative waveguide portion 46 is formed integrally with reflector portion 44 to form a single, unitary assembly.

Similar to reflector portion 22 discussed above, reflector portion 44 can be shaped to define any profile conducive for directing incoherent infrared light from first incoherent infrared light source 40 toward negative waveguide portion 46. More particularly, reflector portion 44 may be shaped to define an elliptic or parabolic profile that is capable of directing incoherent infrared light from incoherent infrared light source 40 along a predetermined direction and distribution within negative waveguide portion 46. In some embodiments, incoherent infrared light source 40 is positioned at the focus of reflector portion 44. In some embodiments, similar to negative waveguide portion 24, negative waveguide portion 46 can be shaped to receive incoherent infrared light from incoherent infrared light source 40 and reflector portion 44 and direct and/or carry this incoherent infrared light to an output end 48 thereof.

During operation, incoherent infrared light source 40 is actuated to output incoherent infrared light. This incoherent infrared light is distributed uniformly and radially from incoherent infrared light source 40. However, any incoherent infrared light that is directed toward reflector portion 44 is redirected and/or focused by reflector portion 44 toward negative waveguide portion 46. Negative waveguide portion 46 further directs and/or carries the incoherent infrared light to output end 48 thereof. Incoherent infrared light exiting output end 48 of negative waveguide assembly 42 is directed through a first transmissive part 50. This incoherent infrared light is then absorbed at a weld line 52 between first transmissive part 50 and a second absorptive part 54. More particularly, incoherent infrared light passes through first transmissive part 50 and is absorbed by second absorptive part 54, or by a surface additive placed between first transmissive part 50 and second part 54, thereby heating and melting first transmissive part 50 and second part 54 along weld line 52. Once first transmissive part 50 and second absorptive part 54 are sufficiently heated through absorption of light energy at weld line 52, first transmissive part 50 and second absorptive part 54 are cooled to result in a welded combination.

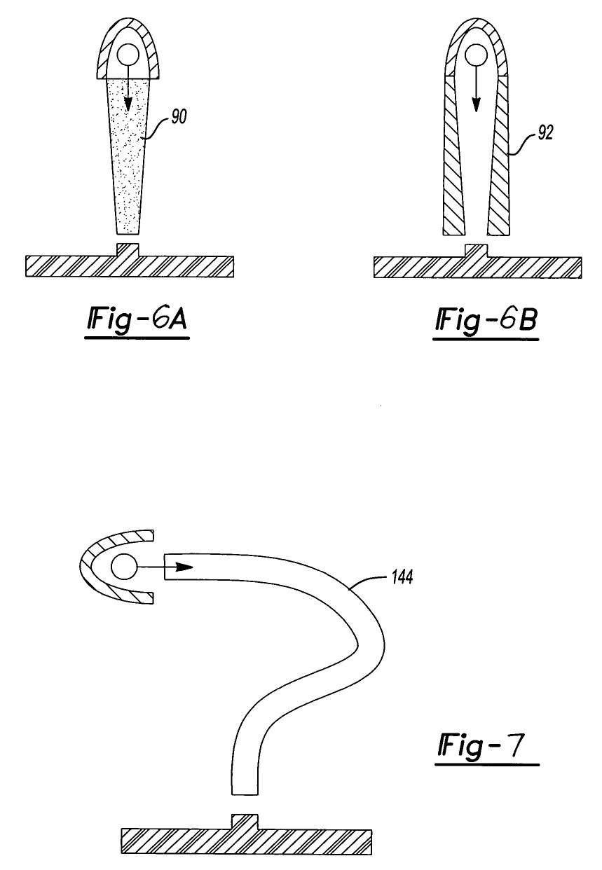

As shown in FIGS. 5 and 6(b), incoherent infrared light from the various incoherent infrared light sources discussed above is directed to a predetermined portion of a part to be welded through a negative waveguide. This negative waveguide precisely controls where incoherent infrared light is directed, thereby greatly enhancing the efficiency that the incoherent infrared light is delivered.

Incoherent infrared light can come from any one of a number of suitable sources generally known today. By way of non-limiting example, the incoherent infrared light sources described herein may include infrared emissive flames, resistive filament heaters, filament bulbs, gas discharge bulbs, black body radiators, radioactive hot bodies, or any other incoherent infrared light source. However, in some embodiments, it has been found that filament halogen bulbs or restive filament heaters maximize cost efficiency, availability, and design flexibility.

Similarly, any one of a number of negative waveguides can be suitable for use in connection with the present invention. The reflective cavity of the negative waveguide could have a polished metal surface or a highly reflective dielectric thin film coating. Moreover, in some embodiments, the negative form could be filled with gas or liquid that is transmissive to incoherent infrared light. Alternatively, the negative form of the waveguide could be vacated to form a vacuum therein. However, the most cost effective embodiment appears to be an air-filled negative metal waveguide with gold plating for its durability, efficiency, and higher wavelength bandwidth.

Generally, a negative waveguide is preferred over a positive waveguide because of its simplicity and higher wavelength bandwidth. Because the incoherent infrared light sources are broadband emitters, the greater wavelength bandwidth of the negative cavity waveguide becomes important.

The plastic parts to be welded in accordance with the present teachings, can be made of a material that is visibly clear, translucent, or opaque. The only requirement is in the part-to-part infrared welding process, which requires that the part must be absorptive to infrared or have a surface additive that is absorptive to infrared in order to weld. For the TTIr process, it is necessary that one part to be welded be transmissive to infrared and the other part to be welded be absorptive to infrared, or instead of the other part being absorptive to infrared, there be an absorptive surface additive between the two parts, in order to create the necessary localized heating to affect a reliable weld surface.

As described herein, plastic can be welded using a bare incoherent infrared light source but a more efficient use of the power is to direct the infrared light more directly to the weld region though some optical means.

One means, commonly used in industry, is to mask the part. This puts the energy only in the weld area, but wastes the majority of the infrared light that the source is emitting.

A second means, which is commonly used in industry, is to reflect the source with a parabolic or elliptical reflector. This can concentrate up to fifty percent of the energy to the weld area, but the other fifty percent spreads out inefficiently.

A third means is to use lensing. Unfortunately, with the blackbody spectrum that most incoherent infrared sources exhibit, glass and plastic lensing do not transmit the majority of the energy of the incoherent infrared light. More exotic infrared materials can be used, and have been used by industry, but due to cost, this approach is rarely chosen.

A fourth means is to use fiber optics or positive dielectric waveguides. For the same reason that glass and plastic lensing is inefficient, fiber optics and positive dielectric waveguides are inefficient because they do not have the transmittance bandwidth for broadband incoherent infrared light using non-exotic materials.

A fifth means, in order to direct the incoherent light into a simple spot, is to use a simple conical optical concentrator downstream from the source. This is an efficient way to concentrate the infrared light to the weld area, but is limited in geometry to a simple spot.

A sixth means, which is novel to the present teachings, is to use a general negative waveguide for incoherent infrared plastics welding. The reflective cavity of the negative waveguide can have a polished metal surface or a highly reflective dielectric thin film coating. Waveguides are approximately three times more efficient than a bare source, and a reflective cavity can efficiently transmit the broadband radiation from an incoherent infrared source throughout its spectrum. A simple conical optical concentrator is a special limited case of a negative waveguide, but is limited in geometry to producing a simple spot. A general negative waveguide is a more general case that has the advantage to being able to conform to just about any weld geometry, both two dimensional and three dimensional, and to accept just about any source geometry. In addition, a negative waveguide can transmit energy around corners, combine multiple sources, and transmit to multiple weld regions.

The best means is to combine a parabolic or elliptical reflector on the backside of the incoherent infrared source with a general negative waveguide downstream of the source, between the source and the weld regions on the parts to be welded.

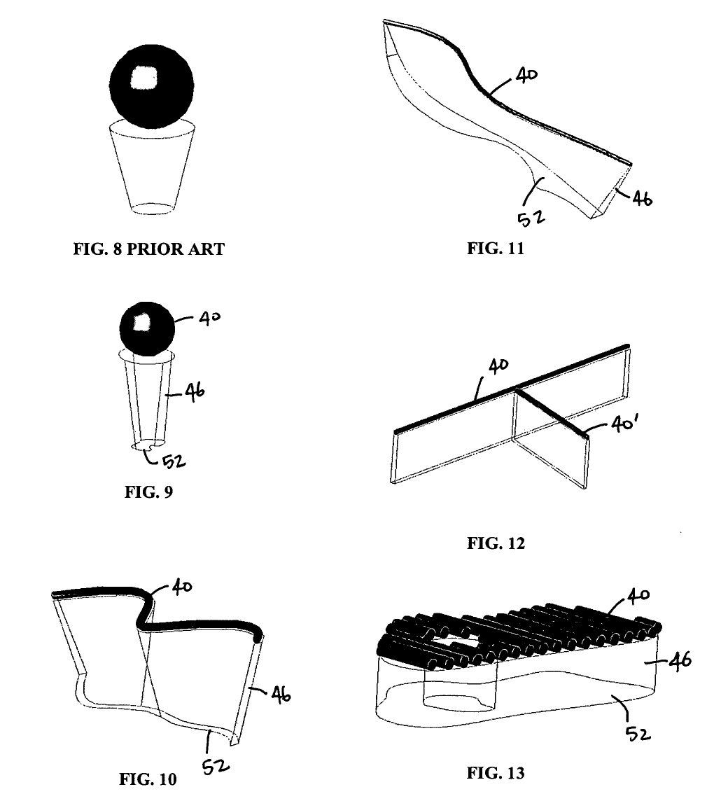

The geometry of a simple conical optical concentrator can be seen in FIG. 8. For clarity, all the figures show the incoherent infrared source in gray, and the waveguides are shown as a positive form, even though it should be understood that the positive form represents the cavity of the negative waveguide. The concentrator is limited to a cone, and produces a simple concentrated round spot forward from the source.

A general negative waveguide on the other hand is a much more complex entity, capable of much more design freedom. The design flexibility can be seen in the following examples.

In FIG. 9, it can be seen that a general negative waveguide can produce a complicated spot shape—more complicated than a simple conic concentrator. It can also produce lines that are straight or curved. The line or curve geometry of the source 40 does not have to conform to the same line or curve geometry of the weld pattern 52 as seen in FIG. 10. In addition, the line width of the weld pattern 52 does not have to be uniform, as seen in FIG. 11. In FIG. 11, a curvilinear light source 40 can be used in connection with a waveguide 46 that varies in width along a curvilinear path. In this way, the weld pattern 52 can define a unique shape. Intersections can also be incorporated into a general negative waveguide as seen in FIG. 12 wherein a first light source 40 and first waveguide 46 intersect at an angle, such as 90° as illustrated, with a second light source 40′ and a second waveguide 46′.

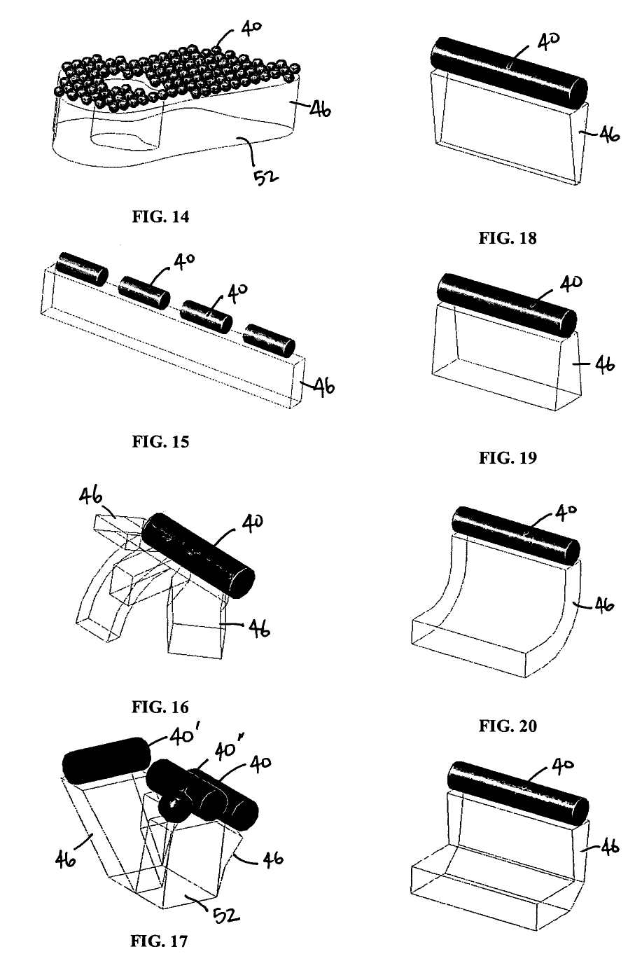

Areas can be illuminated in a defined way by a one dimensional or two dimensional array of broadband infrared emitters 40 contained by a waveguide 46 as seen in FIGS. 13 and 14. Combining spots, lines, intersections, and areas together can produce any arbitrary two dimensional weld pattern.

The illumination of separated sources can be mixed to ensure uniformity of weld pattern 52 as in FIG. 15, wherein a plurality of light sources 40 are coaxially aligned and controlled by a single waveguide 46. However, in some embodiments, a single source 40 can be projected to several places through multiple waveguides 46, 46′, 46″, as seen in FIG. 16. In this way, each of the multiple waveguides 46, 46′, 46″ can be positioned so that their longitudinal axis is at an angle relative to each other. However, several distinct sources 40, 40′, 40″ can be combined to a single weld pattern 52 through one or more waveguides 46 as seen in FIG. 17. A source can be concentrated as seen in FIG. 18, or let to disperse slightly as seen in FIG. 19, to allow for differing source and weld intensities.

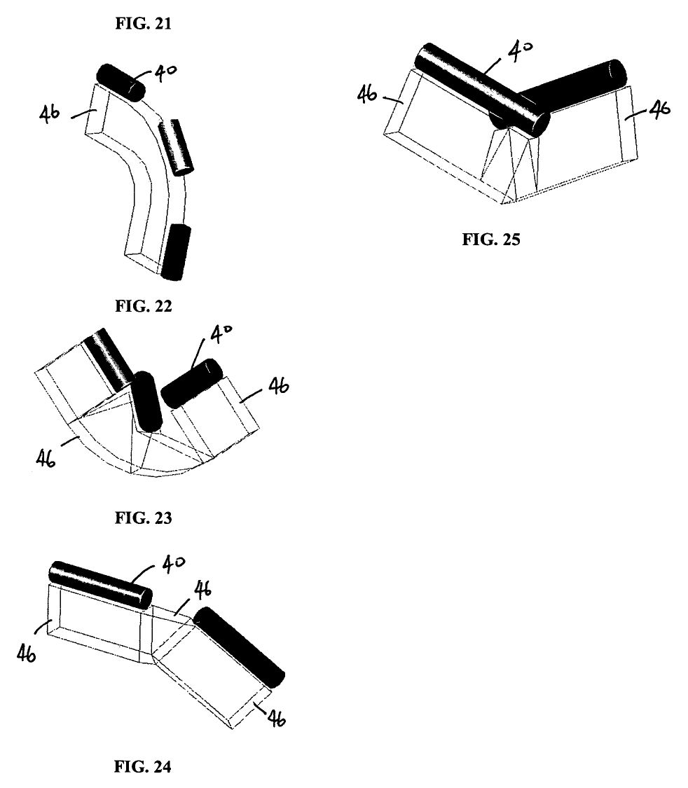

The general negative waveguide can be extended to produce weld geometries in three dimensions. The power from a source can be directed around a corner through a curve as in FIG. 20, or through a bounce plane as in FIG. 21. In this way, the inlet of the waveguide 46 is disposed at an angle relative to the outlet, such as 90° as illustrated. For an outside up and down weld geometry curve (referred to as a frown), separate sources 40 are combined to project a uniform illumination intensity around the curve as seen in FIG. 22. An inside up and down weld curve (referred to as a smile) is more complicated. To achieve uniform intensity, because of the limited room available on the inside curve, the sources 40 are canted relative to the weld line, and a zigzag waveguide is placed in between as seen in FIG. 23. For an outside up and down corner, sources are separated for uniform illumination but have a waveguide connection between them to prevent a cold spot at the corner as seen in FIG. 24. For an inside up and down corner, sources have to be side-by-side, due to the limited inside space, and the waveguide has to overlap, in order to achieve uniform illumination, as seen in FIG. 25. With the combination of being able to direct energy around a corner, and to project energy to the inside and outside of weld curves and corners as well as combining the two dimensional techniques allows for the three dimensional illumination of virtually any weld geometry.

The use of a general negative waveguide for incoherent infrared plastics welding has several advantages. Added optical efficiency as well as precision as to where the infrared light is directed results in less waste heat in the machine, and less power usage. If infrared bulbs are used for the power source, added efficiency allows the bulbs to be used at a lower power, which greatly increases their lifetime. Waveguides allow the geometry of the light source to be different than the geometry of the parts to be welded. This allows for design flexibility of the tooling. This also allows for use of standardized bulbs or filaments at a great cost savings over custom bulbs or filaments. Waveguides also keep infrared light from melting areas on the part that are not to be melted, improving the quality of the welding.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An assembly for plastics welding a first plastic part of a workpiece to a second plastic part of the workpiece, said assembly comprising:
a first incoherent infrared light source that generates incoherent infrared light energy; and
a first negative waveguide having an input end and an output end, said incoherent infrared light energy from said first incoherent infrared light source entering said first negative waveguide at said input end, passing through said first negative waveguide, and exiting said first negative waveguide at said output end, said first negative waveguide having a non-conical longitudinal cross section producing a non-circular weld zone.

2. The assembly according to claim 1, further comprising:
a second incoherent infrared light source that generates incoherent infrared light energy, said incoherent infrared light energy from said second incoherent infrared light source entering said first negative waveguide at said input end, passing through said first negative waveguide, and exiting said first negative waveguide at said output end.

3. The assembly according to claim 2 wherein said first incoherent infrared light source and said second incoherent infrared light source are each elongated and coaxially aligned.

4. The assembly according to claim 2 wherein said first incoherent infrared light source and said second incoherent infrared light source are each elongated and axially offset relative to each other.

5. The assembly according to claim 1, further comprising:
a second negative waveguide having an input end and an output end, said incoherent infrared light energy from said first incoherent infrared light source entering said second negative waveguide at said input end, passing through said second negative waveguide, and exiting said second negative waveguide at said output end, said second negative waveguide being distinct from said first negative waveguide.

6. The assembly according to claim 5 wherein said second negative waveguide is disposed such that a longitudinal axis thereof is disposed at an angle relative to a longitudinal axis of said first negative waveguide.

7. The assembly according to claim 1 wherein said first incoherent infrared light source is elongated and said input end of said first negative waveguide is generally orthogonal to said output end of said first negative waveguide.

8. The assembly according to claim 7 wherein said first negative waveguide comprises an angled surface disposed between said input end and said output end.

9. The assembly according to claim 1 wherein said first negative waveguide is generally U-shaped.

10. The assembly according to claim 1 wherein said first negative waveguide is an elongated tapered member.

11. The assembly according to claim 1 wherein said first negative waveguide is an elongated expanding member.

12. The assembly according to claim 1 wherein said first negative waveguide is an elongated tapered member.

13. The assembly according to claim 1 wherein said first negative waveguide is a curvilinear such that said weld zone is curvilinear.

14. The assembly according to claim 1 wherein said first incoherent infrared light source is curvilinear.

15. The assembly according to claim 1 wherein said output end of said first negative waveguide comprises a variable-width, curvilinear shape.

16. The assembly according to claim 1, further comprising:
a second incoherent infrared light source that generates incoherent infrared light energy; and
a second negative waveguide having an input end and an output end, said incoherent infrared light energy from said second incoherent infrared light source entering said second negative waveguide at said input end, passing through said second negative waveguide, and exiting said second negative waveguide at said output end, said second negative waveguide and said second incoherent infrared light source being disposed at a generally orthogonal angle to said first negative waveguide and said first incoherent infrared light source, respectively.

17. The assembly according to claim 1 wherein said first negative waveguide is U-shaped and said first incoherent infrared light source is positioned in communication with said first negative waveguide along an outer curve of said first negative waveguide.

18. The assembly according to claim 1 wherein said first negative waveguide is U-shaped and said first incoherent infrared light source is positioned in communication with said first negative waveguide along an inner curve of said first negative waveguide.

19. An assembly for plastics welding a first plastic part of a workpiece to a second plastic part of the workpiece, said assembly comprising:
a plurality of incoherent infrared light sources that each generates incoherent infrared light energy; and
a first negative waveguide having an input end and an output end, said incoherent infrared light energy from said plurality of incoherent infrared light sources entering said first negative waveguide at said input end, passing through said first negative waveguide, and exiting said first negative waveguide at said output end, said first negative waveguide having a non-conical longitudinal cross section producing a non-circular weld zone.

20. The assembly according to claim 19 wherein said plurality of incoherent infrared light sources are arranged adjacent each other to form an array.
